(19) United States
(12) Patent Application Publication
(10) Pub. No.: US 2022/0106974 A1
(43) Pub. Date: Apr. 7, 2022

(54) METHOD FOR CONNECTING A PLURALITY OF INDIVIDUAL OBJECTS TO A SUPPORTING STRUCTURE, AND INSTALLATION KIT

(71) Applicant: GESIPA BLINDNIETTECHNIK GMBH, Mörfelden-Walldorf (DE)

(72) Inventors: Sandro SETZER, Mörfelden-Walldorf (DE); Christopher NEIDHARDT, Mörfelden-Walldorf (DE); Christian Kurt MEISSNER FERNÁNDEZ-PACHECO, Mörfelden-Walldorf (DE); Stuart BOOTH, Mörfelden-Walldorf (DE); James Edward Stuart LEATHER, Mörfelden-Walldorf (DE); Bryan Paul TAYLOR, Mörfelden-Walldorf (DE)

(73) Assignee: GESIPA BLINDNIETTECHNIK GMBH, Mörfelden-Walldorf (DE)

(21) Appl. No.: 17/495,025

(22) Filed: Oct. 6, 2021

(30) Foreign Application Priority Data
Oct. 7, 2020 (EP) 20200466.9

(51) Int. Cl. F16B 37/06; F16B 19/10

(52) U.S. Cl. CPC F16B 37/067; F16B 19/1045

(57) ABSTRACT

Method and installation kit for fastening a plurality of individual objects to a supporting structure via blind rivet nuts guided through respective openings in the plurality of individual objects and in the supporting structure, in which an opening in one of the plurality of individual objects and an opening in the supporting structure to be fastened together have different sizes. Each blind rivet nut has a rivet shank and female thread with a same size female thread, and at least two of the blind rivet nuts have different outer sizes. Method includes selecting outer size of one blind rivet nuts according to the size of the opening in the one of the plurality of individual objects and the size of the opening in the supporting structure; screwing a threaded spindle into the female head of the selected blind rivet nut; and forming a closing head by pulling the threaded spindle.

### CROSS-REFERENCE TO RELATED APPLICATIONS

The present application claims priority under 35 U.S.C. § 119 of European Patent Application No. 20200466.9, filed Oct. 7, 2020, the disclosure of which is expressly incorporated by reference herein in its entirety.

### BACKGROUND OF THE INVENTION

### 1. Field of the Invention

The present invention relates to a method for connecting a plurality of individual objects to a supporting structure in which connectors are respectively guided through an opening in an object and an opening in the supporting structure, the openings on the objects and/or the openings on the supporting structure having different sizes.

The invention furthermore relates to an installation kit having a plurality of fasteners.

### 2. Discussion of Background Information

The invention is described below on the basis of solar panels which must be installed in a photovoltaic system.

A photovoltaic system is installed where a high amount of sunlight hours can be expected. Accordingly, suitable locations for photovoltaic systems can often be found in remote areas where adequately trained personnel are not available for installation. Installation thus takes place using auxiliary workers, who must receive instruction.

In many cases, the solar panels are each mounted in a frame, where they are clamped in place or otherwise retained. The frame, in turn, must be attached to a supporting structure, which is also referred to as a “rail.”

Known connectors in this case are screws and bolts. The screw is guided through an opening in the frame and an opening in the supporting structure. A nut is then screwed onto and tightened on the end of the screw that has been guided through the openings.

Another connection option is a lockbolt, in which a fastener must also be guided though the openings in the frame and in the supporting structure. From the opposite side, a locking ring is positioned and pressed together with the bolt. In both cases, accessibility on both sides of the openings is required.

This is further complicated by the fact that there are openings of different sizes in a photovoltaic system. The openings in the supporting structure and/or the openings in the frame are often embodied as elongated holes. For example, in a photovoltaic system there is a first elongated hole size with dimensions of 9×14 mm and a second elongated hole size with dimensions of 7×10 mm. Accordingly, two fastener sizes must be kept in stock and must also be used properly depending on the size of the openings. This makes the installation of the solar panels complicated, time-intensive, and susceptible to errors.

### SUMMARY OF THE INVENTION

Embodiments enable the connection of a plurality of individual objects to a supporting structure in a simple and quick manner.

In this regard, a method of the type named at the outset includes blind rivet nuts having a rivet shank and a female thread are used as fasteners and, through actuation of a pulling device that includes a threaded spindle, which is screwed into the female thread of the respective blind rivet nut, a closing head is formed, wherein at least two blind rivet nuts have different outer sizes and the outer size of the blind rivet nut is selected according to the size of respective openings, wherein the blind rivet nuts comprise female threads of the same size, independent of the outer size of the blind rivet nuts.

In this method, access to the openings in the respective object and in the supporting structure is needed from only one side in each case. The blind rivet nut, which is screwed onto the threaded spindle of a setting tool, can be guided through the opening in the supporting structure and through the opening in the object from one side and then, through a pull on the threaded spindle, what is referred to as the “closing head” can be formed on the other side of the openings. A connection of this type can be produced relatively quickly, even though the threaded spindle must be screwed into the blind rivet nut and unscrewed again after the setting procedure is complete. The blind rivet nut suitable for each case is selected depending on the size of the openings. However, the same setting tool can be used since the same female thread is encountered and the same threaded spindle can therefore be used, despite the blind rivet nuts having different sizes. Thus, the setting tool does not need to be switched out for different blind rivet nuts. This results in a relatively simple installation option. This risk of installation errors is minimized.

The blind rivet nuts preferably have the same setting force or the same setting path, independent of their outer size. The setting tool used to set the blind rivet nuts can thus be used consistently, independent of the outer size of the blind rivet nuts. The tool can be set to either the necessary setting force or the necessary setting path. The blind rivet nuts are set with the required dependability, independent of the outer size thereof.

Preferably, blind rivet nuts are used which comprise an indicator projection on the set head, which projection is sized such that it deforms plastically when the necessary setting force is applied. Thus, it is relatively easy to verify whether the setting force necessary for setting the blind rivet nut, that is, for forming the closing head, has been applied.

Preferably, blind rivet nuts are used, the female thread of which tapers at the closing head-side end. A limiting of the screw-in depth of the threaded spindle on the pulling device is thus enabled. Particularly during the installation of solar panels, there is often only limited clearance available. If it is ensured that the threaded spindle cannot protrude out of the end of the blind rivet nut when the threaded spindle is screwed into the blind rivet nut, the threaded spindle is prevented from being able to cause damage to the fragile and costly solar panels.

Preferably, blind rivet nuts are used which, on the outer side of the rivet shank and/or on the side of the set head facing the rivet shank, comprise a surface structure that presses into the object and/or the supporting structure during the setting of the blind rivet nut. It is thus possible to produce an electrically conductive connection between the blind rivet nut and the object and/or the supporting structure, namely even if the object and/or the supporting structure comprise a surface coating, for example in the form of a finish. An electrically conductive connection is often particularly desirable for the installation of solar panels.

Preferably, blind rivet nuts are used which have different colors and/or markings for different outer sizes. This makes work easier for the installer. He can easily determine the right blind rivet nut for the respective size of the opening.

Preferably, a setting tool is used which requires an authorization in order to change the pulling force or pulling path. The setting tool can then be set in a centralized manner by a foreman or job preparation department, and can be issued to the respective installers. The installers are then only able to use the setting tool to set the blind rivet nut. They cannot, however, make any changes that would impair the quality of the setting procedure. The risk of errors is thus minimized. The authorization can occur in different ways. For example, the entry of a code or the like can be required. Another possibility is that the setting tool can only be programmed by a computer or a control unit with a suitable interface. It is also possible to use a mechanical key which, in one key position, allows a modification of parameters, but does not allow this in another key position, wherein the key can be removed from the setting tool.

In embodiments, an installation kit has a plurality of fasteners, in which kit the fasteners are embodied as blind rivet nuts, each of which including a rivet shank, a set head at an end of the rivet shank, and a female thread in the rivet shank, wherein at least two blind rivet nuts have different outer sizes and the blind rivet nuts with different outer sizes comprise female threads of the same size.

With an installation kit of this type, the installation of a plurality of objects on a supporting structure is then possible even if the objects and/or the supporting structure have openings of different sizes, through which openings the fasteners must be guided. The same setting tool can be used to install the objects on a supporting structure. No changes to the setting tool are necessary in order to set blind rivet nuts with different outer sizes.

Blind rivet nuts with different outer sizes preferably have the same setting force or the same setting path. The setting tool used to set the blind rivet nuts, that is, to form the closing head after the positioning of the blind rivet nut in the respective installation location, can then be operated independently of the outer size of the blind rivet nut. This simplifies installation and minimizes the risk of errors.

Preferably, the set head of the blind rivet nut comprises a plastically deformable indicator projection. The indicator projection is located on the side of the set head facing away from the rivet shank. A pressure piece of the setting tool bears against this location. When the setting tool applies the pulling force necessary for forming the closing head, then the pressure piece of the setting tool acts on the indicator projection and deforms it plastically, provided that the necessary setting force has been applied. This subsequently enables a simple visual verification of whether the setting force has been applied.

Preferably, the female thread tapers at the closing head-side end. A limit for the screwing-in of the threaded spindle of the setting tool is thus achieved, so that the threaded spindle cannot protrude out of the blind rivet nut on the closing head-side end of the blind rivet nut. As a result, the risk of damage to the object is minimized. The blind rivet nut can only be guided through the opening in the supporting structure and the opening on the object until the set head bears against the supporting structure. Accordingly, the length of the rivet shank can be matched to the space available. No additional risks are caused by the threaded spindle.

Preferably, the blind rivet nuts comprise a surface structure on the outer side of the rivet shank and/or on the side of the set head facing the rivet shank. The surface structure is embodied such that it presses into the material of the supporting structure and/or the material of the object when the closing head is being formed. When the closing head is being formed, the rivet shank often widens radially so that the surface structure can press into the perimeter or the peripheral edge of the opening. This enables the production of an electrically conductive contact between the supporting structure and the blind rivet nut and between the object and the blind rivet nut. An electrical conductivity of this type is often desirable for the installation of solar panels.

Preferably, the blind rivet nuts with different outer sizes have different colors. This makes choosing the “right” blind rivet nut easier for the installer. At a glance, he can identify which blind rivet nut he needs to use for a particular fastening situation.

Embodiments are directed to a method for fastening a plurality of individual objects to a supporting structure via blind rivet nuts guided through respective openings in the plurality of individual objects and in the supporting structure, in which an opening in one of the plurality of individual objects and an opening in the supporting structure to be fastened together have different sizes. Each blind rivet nut has a rivet shank and female thread with a same size female thread, and at least two of the blind rivet nuts have different outer sizes. The method includes selecting an outer size of one of the at least two blind rivet nuts according to the size of the opening in the one of the plurality of individual objects and the size of the opening in the supporting structure; screwing a threaded spindle into the female thread of the selected blind rivet nut; and forming a closing head by pulling the threaded spindle.

According to embodiments, the blind rivet nuts can have a same setting force or a same setting path, independent of their outer size.

In accordance with other embodiments, the blind rivet nuts may include an indicator projection on a set head that is sized such that it deforms plastically when the setting force is applied.

In other embodiments, the female thread can taper at a closing head-side end.

According to other embodiments, the blind rivet nuts may further include a surface structure on at least one of an outer side of the rivet shank thereof or on a side of the set head facing the rivet that presses into at least one of the at least one of the plurality of objects or the supporting structure during a setting of the blind rivet nut.

In still other embodiments, the blind rivet nuts may be provided with at least one of different colors or different markings to identify the different outer sizes.

According to embodiments, the blind pivot nut may be set by a setting tool, and upon the setting tool receiving authorization, a pulling for or pulling path of the setting tool can be changed.

Embodiments are directed to an installation kit that includes a plurality of fasteners embodied as blind rivet nuts, in which each of the blind rivet nuts includes a rivet shank, a set head at an end of the rivet shank, and a female thread with a same female thread size in the rivet shank. At least two of the blind rivet nuts have different outer sizes.

According to embodiments, the at least two blind rivet nuts with different outer sizes may have a same setting force or a same setting path, independent of their outer size.

In accordance with other embodiments, the set head of the at least two blind rivet nuts can include a plastically deformable indicator projection.

In other embodiments, the female thread may taper at the closing head-side end.

According to still other embodiments, the at least two blind rivet nuts may include a surface structure on at least one of an outer side of the rivet shank or on a side of the set head facing the rivet shank.

In accordance with still yet other embodiments, the at least two blind rivet nuts may be different colors for the different outer sizes.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a schematic illustration for the purpose of explaining the connection of an object to a supporting structure;

FIGS. 2A and 2B show a schematic illustration of two different sizes of available openings;

FIG. 3 shows a schematic illustration of a blind rivet nut, partially in section; and

FIG. 4 shows part of an installation kit with blind rivet nuts, partially in section.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

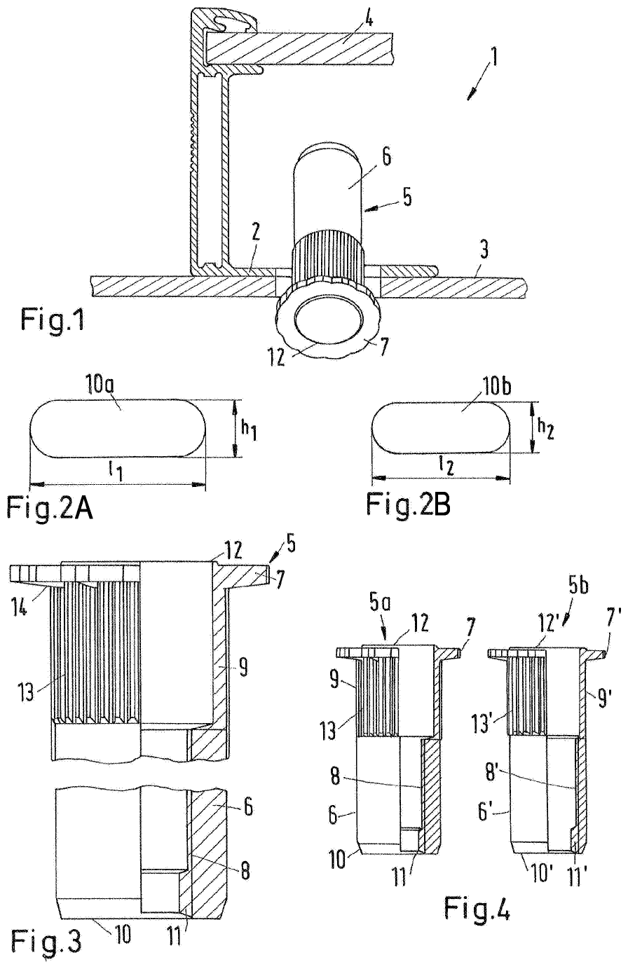

FIG. 1 schematically shows an installation arrangement 1 in which an object 2, e.g., in the form of a frame, must be attached to a supporting structure 3, in the form of a rail. The object 2 can, by way of non-limiting example, be configured to a solar panel 4. Installation arrangement 1 of this type occurs, for example, during the installation of a plurality of solar panels 4 in a photovoltaic system. In this case, hundreds or even thousands of objects 2 must be installed on supporting structures 3.

To connect an individual object 2 to the supporting structure 3, a blind rivet nut 5 is used. The blind rivet nut comprises a rivet shank 6 and a set head 7 at an end of the rivet shank 6. As can be seen in FIG. 3 in particular, a female thread 8 is embodied in the rivet shank 6. To set the blind rivet nut 5, a threaded spindle, which is not shown in greater detail, of a setting tool is first screwed into the female thread 8 of the blind rivet nut 5. The blind rivet nut 5 is then guided through an opening in the supporting structure 3 and an opening in the object 2, until the set head 7 bears against the supporting structure 3. The setting tool is then actuated and exerts, for example via an electric or pneumatic drive, a pulling force on the female thread 8, which pulling force causes a deformation region 9 of the shank 6 to deform and a closing head to form, as is known from blind rivet nuts. The closing head then bears against the object 2 on the side of the object 2 facing away from the supporting structure 3. The object 2 is then connected to the supporting structure 3.

As is shown in FIGS. 2A and 2B, there are different sizes of openings that can be formed in the supporting structure 3 or in the object 2, or in the supporting structure 3 and the object 2. These openings are often embodied as elongated holes. For example, there can be a first opening 10a with a length 11 of 14 mm and a height h1 of 9 mm. There can also be a second opening 10b with a length 12 of 10 mm and a height h2 of 7 mm.

In photovoltaic systems, e.g., the objects 2 or the frames, may often be formed out of aluminum and have, at least in a region which bears against the supporting structure 3, a relatively small thickness, for example 2 mm. This leads to the problem of object 2 becoming detached or otherwise deformed in the region of the elongated hole if the closing head is not formed with the “right” size. It is therefore necessary to select an appropriate blind rivet nut 5 for each size of the openings 10a, 10b.

Therefore, as is shown in FIG. 4, plural, e.g., two (or more) blind rivet nuts 5a and 5b having different outer sizes may be provided. Specifically, in FIG. 4, a blind rivet nut 5a is illustrated, which can include a rivet shank 6 having a diameter that fits the height h1 of the first opening 10a, and a blind rivet nut 5b is also illustrated, which can include a rivet shank 6′ having a diameter that fits the height h2 of the second opening 10b. Typically, the diameter of rivet shank 6, 6′ must be slightly smaller than a respective height h1, h2, as a result of which the blind rivet nut 5a can have a rivet shank diameter of roughly 8.9 mm and the blind rivet nut 5b can have a rivet shank diameter of roughly 6.9 mm, for example.

However, female thread 8, 8′ on the blind rivet nuts 5a, 5b can be embodied identically, for example with the size M5. This holds true independently of the outer size of blind rivet nut 5a, 5b, and, in particular, independently of the diameter of the rivet shank 6.

It is evident that, in the region of the female thread 8, rivet shank 6 of blind rivet nut 5a has a greater thickness than rivet shank 6′ of blind rivet nut 5b. This is non-critical, however, since a deformation of the respective blind rivet nut 5a, 5b normally does not occur in the region of the female thread 8, but rather in deformation region 9, as mentioned previously. In this case, blind rivet nuts 5a, 5b can be sized such that they have a same setting force, or alternatively, a same setting path, independent of their outer size.

The set head 7 (7′) is arranged at an end of rivet shank 6 (6′). The opposite end of the rivet shank 6 constitutes the “closing head-side” end 10 (10′). The female thread 8 tapers at the closing head-side end, for example in that a projection 11 (11′) that protrudes radially inwards is provided there. This projection 11 (11′) prevents a threaded mandrel from being able to be screwed into the female thread 8 (8′) far enough that it protrudes out of the rivet shank at the closing head-side end 10 (10′).

The set head 7 (7′) comprises an indicator projection 12 (12′) on the end thereof which faces away from the rivet shank 6 (6′). The indicator projection 12 (12′) is sized such that it deforms plastically when the necessary setting force is applied. For the formation of the closing head, which is not illustrated in greater detail, a certain setting force is necessary. After the setting of the blind rivet nut 5a (5b), it is easy to visually verify whether this setting force has been applied. If the setting force has been applied, the indicator projection 12 (12′) will be deformed. If the setting force has not been applied, for example because the setting procedure has been interrupted before the complete formation of the closing head, then the indicator projection 12 (12a′) will not be sufficiently deformed, which can be determined visually without difficulty.

As can be seen in FIGS. 1, 3, and 4, rivet shank 6 (6′) comprises a surface structure 13 (13′) on the perimeter thereof. It is sufficient if the surface structure 13 (13′) is embodied in the deformation region 9 (9′) of the rivet shank 6 (6′). In principle, it is also sufficient if the surface structure 13 (13′) is embodied in a region of the rivet shank 6 (6′) that slightly deforms radially outwards during the formation of the closing head. During the formation of the closing head, that is, when the necessary setting force is applied, the surface structure 13 (13′) presses into the edge of the opening of the object 2 and supporting structure 3 and thus enables the production of an electrically conductive connection between the object 2 and the supporting structure 3.

The set head 7 can also comprise a surface structure 14 on the side thereof facing the rivet shank 6. The surface structure 14 of the set head then presses into the surface of the supporting structure 3 against which the set head 7 bears during the setting of the blind rivet nut 5.

To allow blind rivet nuts 5a to be distinguished from the blind rivet nuts 5b, blind rivet nuts 5a and 5b can differently colored or have other markings that are visually or haptically perceptible. For example, blind rivet nuts 5b having the smaller outer size can be colored black and the blind rivet nuts 5a with the larger outer size can be left without any color application.

To attach objects 2 to supporting structure 3, the installer selects a blind rivet nut 5a, 5b which fits the respective opening 10a, 10b. However, the installer can use the same setting tool independently of the chosen blind rivet nut 5a, 5b, since, because both blind rivet nuts 5a, 5b comprise a same female thread 8, the setting tool does not need to be changed regardless of the selected blind rivet nut size.

Additionally, the setting tool is preset, e.g., either the setting force or the setting path can be set.

The preset cannot be changed by the installer without additional steps. An authorization is required to modify the respective preset. The authorization can occur, for example, via the entry of a code or via a mechanical key or special tool that is only available to authorized persons. Another possibility is that the setting or “programming” of the setting tool takes place via a computer or a control device that is likewise not accessible to all persons, but rather only to persons authorized therefor, for example a foreman or a job preparation department.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A method for fastening a plurality of individual objects to a supporting structure via blind rivet nuts guided through respective openings in the plurality of individual objects and in the supporting structure, wherein an opening in one of the plurality of individual objects and an opening in the supporting structure to be fastened together have different sizes, and wherein each blind rivet nut has a rivet shank and female thread with a same size female thread, and at least two of the blind rivet nuts have different outer sizes, the method comprising:
selecting an outer size of one of the at least two blind rivet nuts according to the size of the opening in the one of the plurality of individual objects and the size of the opening in the supporting structure;
screwing a threaded spindle into the female thread of the selected blind rivet nut;
forming a closing head by pulling the threaded spindle.

2. The method according to claim 1, wherein the blind rivet nuts have a same setting force or a same setting path, independent of their outer size.

3. The method according to claim 1, wherein the blind rivet nuts include an indicator projection on the set head that is sized such that it deforms plastically when the setting force is applied.

4. The method according to claim 1, wherein the female thread tapers at a closing head-side end.

5. The method according to claim 1, wherein the blind rivet nuts further include a surface structure on at least one of an outer side of the rivet shank thereof or on a side of the set head facing the rivet that presses into at least one of the at least one of the plurality of objects or the supporting structure during a setting of the blind rivet nut.

6. The method according to claim 1, wherein the blind rivet nuts are provided with at least one of different colors or different markings to identify the different outer sizes.

7. The method according to claim 1, wherein the blind pivot nut is set by a setting tool, and wherein, upon the setting tool receiving authorization, a pulling for or pulling path of the setting tool is changeable.

8. An installation kit comprising:
a plurality of fasteners embodied as blind rivet nuts, wherein each of the blind rivet nuts includes a rivet shank, a set head at an end of the rivet shank, and a female thread with a same female thread size in the rivet shank,
wherein at least two of the blind rivet nuts have different outer sizes.

9. The installation kit according to claim 8, wherein the at least two blind rivet nuts with different outer sizes have a same setting force or a same setting path, independent of their outer size.

10. The installation kit according to claim 8, wherein the set head of the at least two blind rivet nuts comprises a plastically deformable indicator projection.

11. The installation kit according to claim 8, wherein the female thread tapers at the closing head-side end.

12. The installation kit according to claim 8, wherein the at least two blind rivet nuts comprise a surface structure on at least one of an outer side of the rivet shank or on a side of the set head facing the rivet shank.

13. The installation kit according to claim 8, wherein the at least two blind rivet nuts are different colors for the different outer sizes.
